(19) United States
(12) Patent Application Publication
(10) Pub. No.: US 2012/0192180 A1
(43) Pub. Date: Jul. 26, 2012

(54) PLAYING TELEVISION PROGRAM IN VIRTUAL ENVIRONMENT

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/234,009

(22) Filed: Sep. 15, 2011

(30) Foreign Application Priority Data
Jan. 25, 2011 (TW) 100102737

(51) Int. Cl. G06F 9/455

(52) U.S. Cl. 718/1

(57) ABSTRACT

In a virtual environment, a virtual machine (VM) host includes a host screen and a first host window displayed in the host screen. A VM guest is instantiated on the VM host. The VM guest includes a guest screen that is presented in the first host window. The VM launches a television player application and instructs the television player application to play a television program in the guest screen. The VM host generates one or more key words according to program information of the television program and sends a query request with the one or more key words to a remote server via a network. After receiving return information from the remote server, the VM host creates a second host window displayed in the host screen and displays the return information in the second host window.

### CROSS-REFERENCE TO RELATED APPLICATIONS

Relevant subject matter is disclosed in co-pending U.S. patent applications entitled “PLAYING TELEVISION PROGRAM IN VIRTUAL ENVIRONMENT”, Attorney Docket Number US37795, U.S. application Ser. No. ______, Filed on ______, and “PLAYING TELEVISION PROGRAM IN VIRTUAL ENVIRONMENT”, Attorney Docket Number US37796, U.S. application Ser. No. ______, Filed on ______.

### BACKGROUND

1. Technical Field

The disclosure generally relates to a method and a system for playing a television program in a virtual environment.

2. Description of Related Art

A user may watch television programs via a computer, which has a TV tuner module such as a built-in TV tuner card or a USB TV tuner stick. The TV tuner module is able to receive and process television signals and output video/audio stream. Many of the television programs are TV shopping programs, which provide the television viewers with sale information of goods. However, the sale information provided by those TV shopping programs often cannot fully meet the requirements of the viewer since the viewer desires more and more information. For example, the viewer may want to get more price information of a product in order to make an optimum decision from among a number of sellers. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a computer system in which virtual machines are configured.

FIG. 2 is a schematic diagram of one embodiment of a network, which the computer system can operate.

FIG. 3 illustrates a first view of one embodiment of a graphic user interface for displaying host windows in a host screen of a VM host.

FIG. 4 illustrates a second view of one embodiment of a graphic user interface for displaying host windows in the host screen of the VM host.

FIG. 5 illustrates a third view of one embodiment of a graphic user interface for displaying host windows in the host screen of the VM host.

FIG. 6 is an operational flow diagram representing an exemplary embodiment of a method of playing a television program in a computer system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

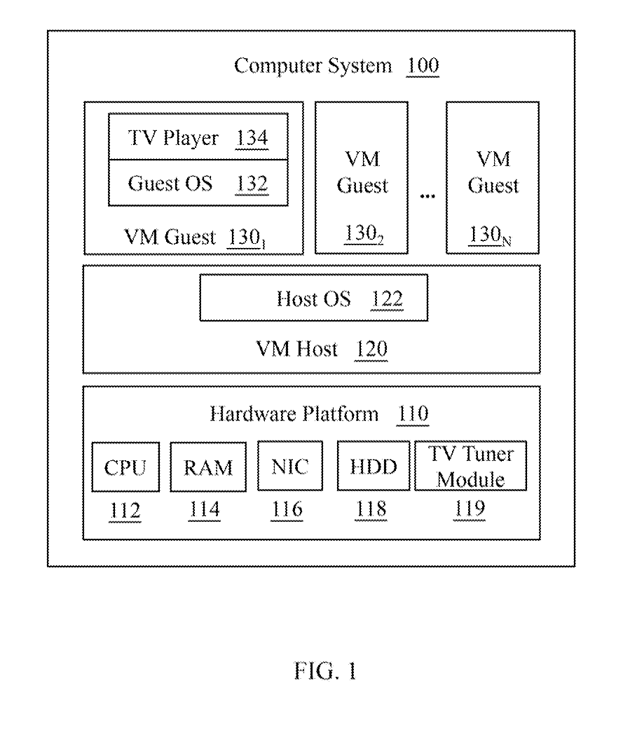

FIG. 1 depicts a block diagram of virtual machines that are configured on a computer system 100. The computer system 100 may be constructed on a desktop, a laptop or on a server grade hardware platform 110 such as an x86 architecture platform. Such a hardware platform may include a central processing unit (CPU) 112, a random access memory (RAM) 114, a network interface controller (NIC) 116 (also referred to as a network card), a hard disk drive (HDD) 118, a TV tuner module 119 and other I/O devices such as a mouse and a keyboard (not shown in FIG. 1).

The computer system 100 can operate one or more virtual machine (VM) guests 130₁, 130₂ . . . 130_{N}, collectively designated by a reference numeral 130, by installing a VM host 120 with a host operating system (OS) 122 for operating the VM guests 130. Each of the VM guests 130 may include a guest OS and one or more software applications. For example, the VM guest 130₁ includes a guest OS 132 and a TV player application 134 that is installed and executable in the VM guest 130₁.

The VM host 120 may control the hardware platform 110, present to the VM guests 130 virtualized hardware resources, and manage the VM guests 130. Multiple instances of the VM guests 130 may share the virtualized hardware resources and each of them may execute programs as if it was a physical machine.

The VM host 120 may provide a host window, in which a guest screen of one of the VM guests 130 can be presented. Each of the VM guests 130 may run multiple software applications in the corresponding host window. One software application of a VM guest may form one or more guest windows displayed in the guest screen of the VM guest to play as a user interface for itself.

The TV tuner module 119 may receive and process television signals and output video/audio stream. The television signals may be analog television signals or digital television signals, which depends on the television service provider. The TV tuner module 119 may be a TV tuner card with a PCI interface or a TV tuner stick with a USB interface. In some embodiments, the TV tuner module 119 may include a remote control receiver that may receive and identify remote commands from a remote control.

The TV player application 134, which is installed in the VM guest 130₁, may operate and control the TV tuner module 119 to expose all features of the TV tuner module 119. The TV player application 134 may play the video/audio stream generated by the TV tuner module 119.

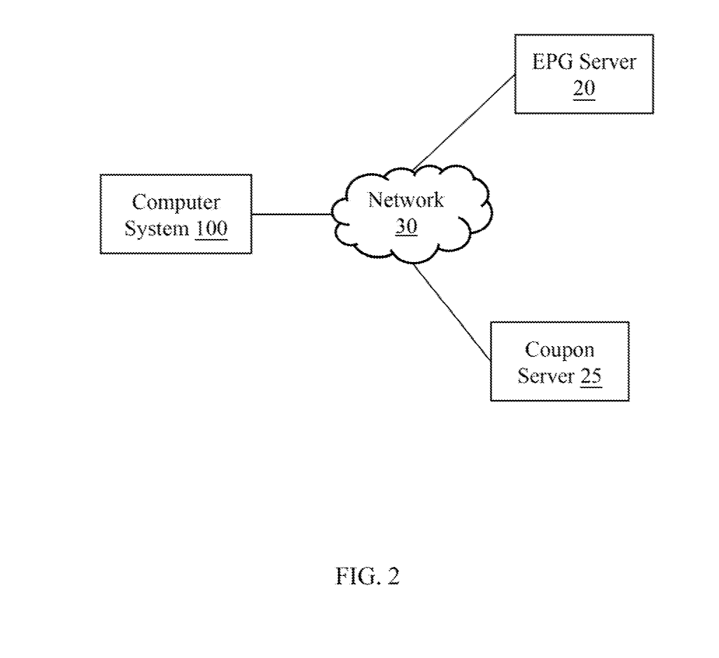

With reference to FIG. 2, the computer system 100 may operate in a network 30 using logical connection to one or more remote computers through the NIC 116. The network 30 may be a local area network (LAN) or a wide area network (WAN). The NIC 116 may be a network adapter card using a specific physical layer and a data link layer standard such as Ethernet or Wi-Fi. When used in a WAN networking environment, the computer system 100 typically includes a modem or other means for establishing communications over the WAN, such as the Internet.

The computer system 100 may be in communication with an electronic program guide (EPG) server 20 and a coupon server 25 via the network 30. The EPG server 20 may provide an EPG service. An EPG may provide users of television with continuously updated scheduling information for current and upcoming television programs. The television service provider via a television network, which is carried on the digital television signals, may also provide the EPG.

The coupon server 25 stores a plurality of coupons. A coupon can be exchanged for financial discount or rebate when purchasing a product, for example, a smart phone. The coupon server 25 may be provided by a web site, such as COUPONS.COM®.

The computer system 100 may assign a unique Internet protocol (IP) address for each of the VM guests 130 manually or automatically. The computer system may create an Address Resolution Protocol (ARP) table that stores and maintains IP addresses of the VM guests 130. The ARP table may further store a VM ID or an MAC address to mark a unique IP address for each VM guest. The VM ID is an identification key to identify a unique VM guest. The VM host 120 assigns the MAC address when the corresponding VM guest is created. Each of the VM guests 130 has a unique MAC address, which can be recognized in a local area network (LAN) or a wide area network (WAN) such as the Internet. The IP address of a VM guest can be acquired from the ARP table according to either the VM ID or the MAC address of the VM guest.

The VM host 120 may establish a connection channel based on transmission control protocol (TCP) between the VM host 120 and each of the VM guests 130. For example, when a connection channel is established between the VM host 120 and the VM guest 130₁, the VM host 120 and the VM guest 130₁ can communicate with each other.

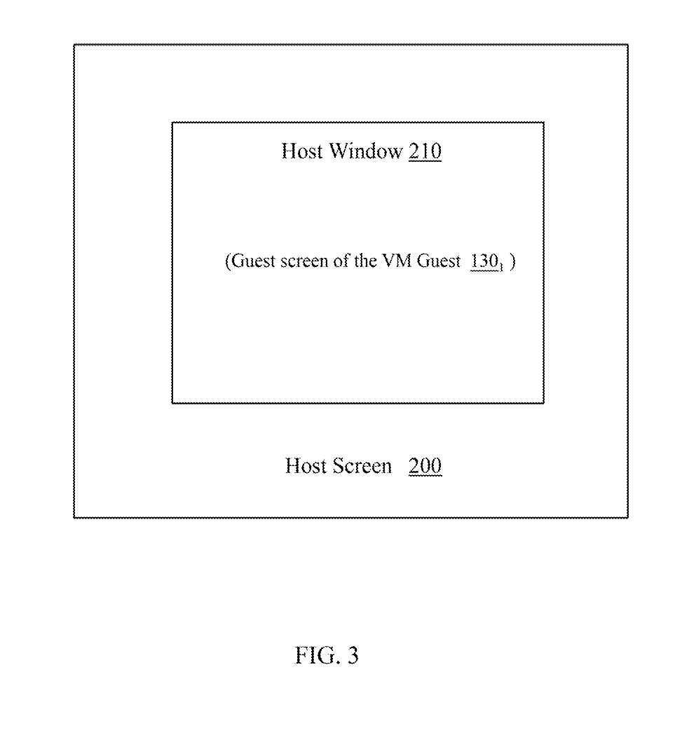

In FIG. 3, one embodiment of a graphic user interface for displaying a host window 210 in a host screen 200 of the VM host 120 is shown. A guest screen of the VM guest 130₁ is presented in the host window 210. The VM guest 130₁ may run arbitrary software applications and display the corresponding windows of the software applications in the guest screen of the VM guest 130₁.

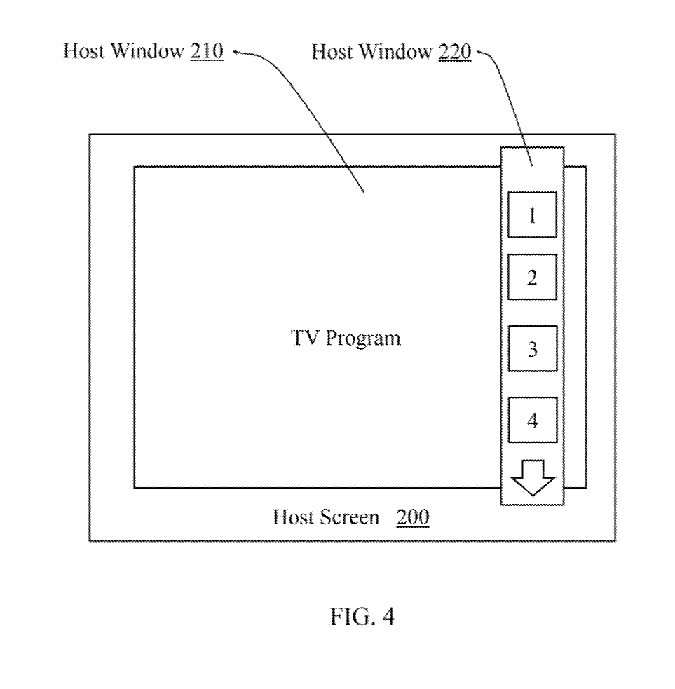

In FIG. 4, the VM guest 130₁ launches the TV player application 134 and instructs the TV player application 134 to play a television program in the guest screen of the VM guest 130₁ presented in the host window 210.

The VM host 120 may generate one or more key words according to program information of the television program that is being played by the TV player application 134. The VM host 120 may obtain the program information from an EPG. The VM host 120 may connect to the EPG server 20 and download an EPG from the EPG server 20 via the network 30. If the television program is supplied by digital television signals, the VM guest 1301 may instruct the TV player application 134 to extract an EPG from the digital television signals and transmit the EPG to the VM host 120 via the connection channel established between the VM host 120 and the VM guest 130₁. The VM host 120 may obtain the current television program information from the EPG and generate one or more key words, which are related to the television program.

In some embodiments, if the television program is supplied by digital television signals, the VM guest 1301 may instruct the TV player application 134 to extract closed captions from the digital television signals and transmit the closed captions to the VM host 120. The VM host 120 thus may generate one or more key words according to the closed captions.

The VM host 120 may send a query request with the one or more key words to the coupon server 25 via the network 30. The coupon server 25 may return one or more coupons according to the one or more key words to the VM host 120.

When the VM host 120 receives the one or more coupons from the coupon server 25, the VM host 120 can create a host window 220 displayed in the host screen 200 and display the one or more coupons in the host window 220. The host window 220 may be presented near one of the sides of the host window 210 and partially overlap the host window 210. For example, the host window 220 may be laid on the right side of the host window 210. In order not to disturb the viewer, the VM host 120 may provide the host window 220 with a transparent background. In some embodiments, the host window 220 may be in a long and narrow shape.

The VM host 120 may hide the host window 220 when the remote control receiver of the TV tuner module 119 receives a hide command from a remote control. When a unhide command is received and identified by the remote control receiver, the VM host 120 may unhide the host window 220.

When too many coupons are received from the coupon server 25 or the data of each of the coupons is too much to display in the host window 220 at one time, the VM host 120 may display the profiles of the coupons in the host window 220, for example the coupon titles, the coupon images and the abstracts. In FIG. 4, the VM host 120 displays four coupon profiles in every page of the host window and may turn the pages by clicking a page turning button.

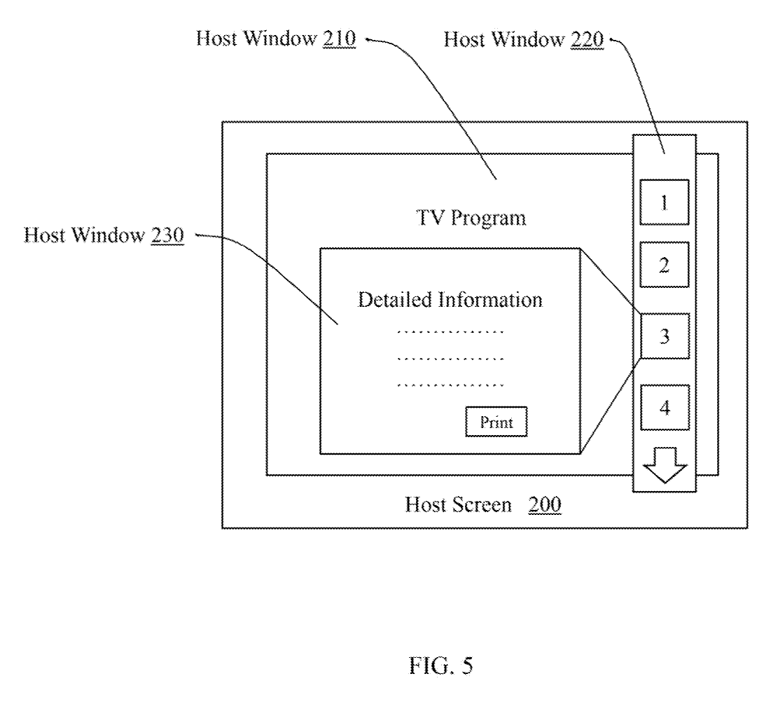

In FIG. 5, the coupon item 3 is selected according to a user selection. The VM host 120 may create a host window 230 and display the detailed information of the selected coupon item 3 in the host window 230. The host window 230 is laid on top of the host window 210 and has a smaller size as the size of the host window 210. In some embodiments, the VM host 120 may be coupled to a printer and instruct the printer to print the selected coupon 3 when the user clicks the print button in the host window 210.

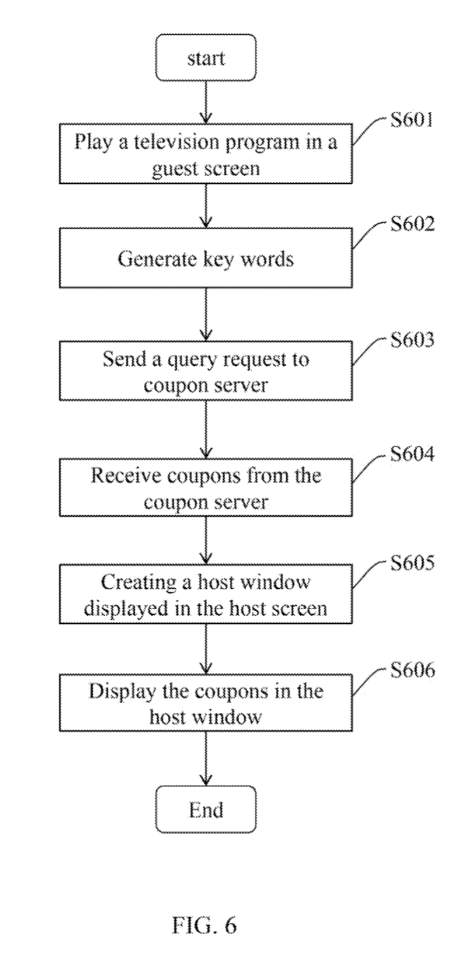

FIG. 6 is a flowchart illustrating one embodiment of a method of playing a television program in the computer system 100. The method may include the following steps.

In step S601, the VM guest 130₁ launches the TV player application 134 and instructs the TV player application 134 to play a television program in the guest screen of the VM guest 130₁ which is presented in the host window 210.

In step S602, the VM host 120 may generate one or more key words according to program information of the television program, which is being played by the TV player application 134.

In step S603, the VM host 120 sends a query request with the one or more key words to the coupon server 25 via the network 30.

In step S604, the VM host 120 receives one or more coupons from the coupon server 25. According to the one or more key words, the coupon server 25 determines the one or more coupons.

In step S605, the VM host 120 creates a host window 220 displayed in the host screen 200.

In step S606, the VM host 120 displays the one or more coupons in the host window 220.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for playing a television program, the method comprising:
providing a computer system comprising a virtual machine (VM) host and a VM guest instantiated on the VM host, the VM host having a host screen and a first host window displayed in the host screen, the VM guest having a guest screen that is presented in the first host window and a television player application;
launching the television player application and instructing the television player application to play the television program in the guest screen by the VM guest;
generating one or more key words according to program information of the television program by the VM host;
sending a query request with the one or more key words to a remote server via a network by the VM host;
receiving return information associated with the one or more key words from the remote server by the VM host;
creating a second host window displayed in the host screen by the VM host; and
displaying the return information in the second host window by the VM host.

2. The method of claim 1, further comprising obtaining the program information from an electronic program guide (EPG).

3. The method of claim 2, further comprising connecting to an EPG server and downloading the EPG from the EPG server via the network by the VM host.

4. The method of claim 2, further comprising extracting the EPG from digital television signals.

5. The method of claim 1, further comprising obtaining the program information from closed captions within the television program.

6. The method claim 5, further comprising extracting the closed captions from digital television signals.

7. The method of claim 1, wherein the return information comprises one or more coupons concerning the one or more key words.

8. The method of claim 7, further comprising:
selecting a target coupon from the one or more coupons according to a user selection from the second host window;
creating a third host window displayed in the host screen by the VM host; and
displaying detailed information of the target coupon in the third host window by the VM host.

9. The method of claim 8, further comprising printing the detailed information of the target coupon displayed in the third host window by the VM host.

10. The method of claim 1, further comprising hiding the second host window when a remote control receiver of the computer system receives a hiding command.

11. A computer system comprising:
a virtual machine (VM) host having a host screen and a first host window displayed in the host screen;
a VM guest instantiated on the VM host, the VM guest having a guest screen that is presented in the first host window and a television player application;
wherein the VM guest is adapted to launch the television player application and instruct the television player application to play a television program in the guest screen, the VM host is adapted to generate one or more key words according to program information of the television program, send a query request with the one or more key words to a remote server via a network, receive return information associated with the one or more key words from the remote server, create a second host window displayed in the host screen, and display the return information in the second host window.

12. The computer system of claim 11, wherein the VM host is further adapted to obtain the program information from an electronic program guide (EPG).

13. The computer system of claim 12, wherein the VM host is further adapted to connect to an EPG server and download the EPG from the EPG server via the network.

14. The computer system of claim 12, wherein the VM guest is further adapted to extract the EPG from digital television signals and transmit the EPG to the VM host.

15. The computer system of claim 11, wherein the VM host is further adapted to obtain the program information from closed captions within the television program.

16. The computer system claim 15, wherein the VM guest is adapted to extract the closed captions from digital television signals and transmit the closed captions to the VM host.

17. The computer system of claim 11, wherein the return information comprises one or more coupons concerning the one or more key words.

18. The computer system of claim 17, wherein the VM host is further adapted to select a target coupon from the one or more coupons according to a user selection from the second host window, create a third host window displayed in the host screen, and display detailed information of the target coupon in the third host window.

19. The computer system of claim 11, wherein the second host window partially overlaps the first host window.

20. The computer system of claim 11, further comprising a remote control receiver adapted to receive a hiding command from a remote control, wherein the VM host is further adapted to hide the second host window when the remote control receiver receives the hiding command.
